(19) United States
(12) Patent Application Publication
(10) Pub. No.: US 2008/0023637 A1
(43) Pub. Date: Jan. 31, 2008

(54) Radiation detector for X-rays or gamma rays

(76) Inventors: Bjorn Heismann, Erlangen (DE); Wilhelm Metzger, Munchen (DE); Khanh Pham Gia, Neubiberg (DE); Stefan Wirth, Erlangen (DE)

Correspondence Address: HARNESS, DICKEY & PIERCE, P.L.C., P.O.BOX 8910, RESTON, VA, 20195, US

(21) Appl. No.: 11/826,739

(22) Filed: Jul. 18, 2007

(30) Foreign Application Priority Data
Jul. 19, 2006 (DE) 10 2006 033 496.5

(51) Int. Cl. G01T 1/20

(52) U.S. Cl. 250/366

(57) ABSTRACT

A radiation detector is disclosed for X radiation. In at least one embodiment, the detector includes a detector array that has a multiplicity of scintillators separated from one another by partition walls, and a photodiode array that is arranged on the side of said detector array averted from the radiation. In at least one embodiment, electronic subassemblies are arranged in an insensitive region of the photodiodes that is covered by the partition walls, and the partition walls include a material that has an X-ray absorptivity of more than 50%.

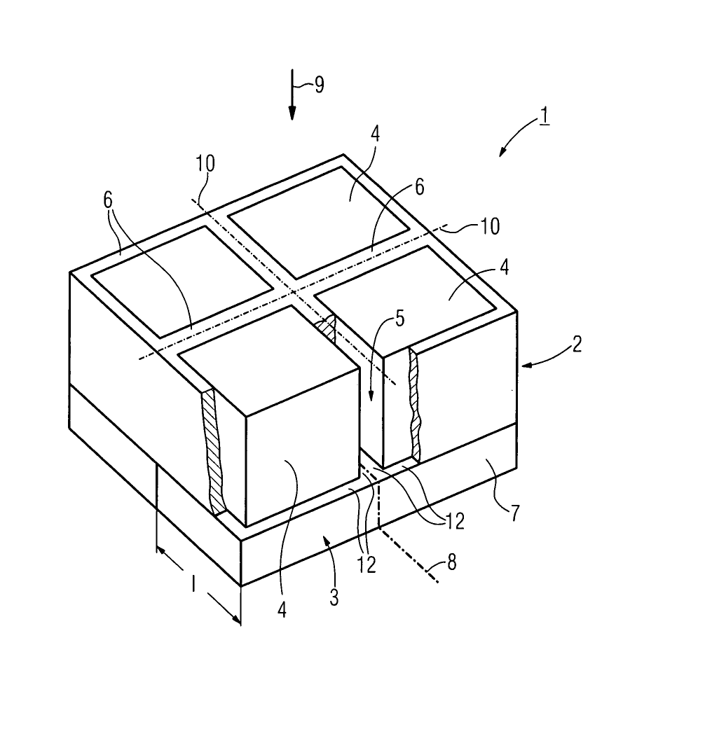

### PRIORITY STATEMENT

The present application hereby claims priority under 35 U.S.C. §119 on German patent application number DE 10 2006 033 496.5 filed Jul. 19, 2006, the entire contents of which is hereby incorporated herein by reference.

### FIELD

Embodiments of the invention generally relate to a radiation detector for X-rays or gamma rays. For example, the detector may be one which is used, for example, in computer tomography, and comprises a detector array having a multiplicity of scintillators. A scintillator, in turn, may be one which includes a scintillator material that absorbs the gamma radiation or X radiation and converts it into physical light. Only X radiation will be referred to below, in order to simplify matters. Examples of scintillator materials are materials doped with activators, such as Gd₂O₂S:Pr, (Y,Gd)₂O₃:EU,Pr,Gd₃GaₛO12:Cr,Ce or CsI:T1. A photodiode array may be arranged below the detector array or on the side thereof averted from the incident radiation, in order to detect the light emitted by the scintillators. The pixel size of the photodiode array corresponds approximately to the pixel size of the detector array, which is, for example, in the region of 1 mm×1 mm.

### BACKGROUND

In the case of present day computer tomographs, which are an important field of application for the radiation detectors under discussion, the scintillators are arranged in the form of two-dimensional arrays whose flat plane is aligned perpendicular to the incident radiation. In order to ensure a high image resolution, it is necessary to suppress a lateral light propagation in the detector array, and thus to achieve a good separation of the light signals of the individual pixels. These are therefore separated from one another with the aid of reflecting partition walls, so called septa. The material of the partition walls is to have a high diffuse reflectivity and a low absorptivity and transmissivity for the scintillation light, in order to ensure a high light yield and a low crosstalk of the light signals relating to neighboring scintillators. The partition walls, which usually have a width of 50 μm to 500 μm, mostly consist of a binder matrix to which there is admixed a pulverulent material of high refractive index, for example TiO₂ particles.

Electronic signal processing requires appropriate electronic subassemblies, for example preamplifiers. Such subassemblies are generally sensitive to the X radiation prevailing in the region of the photodiode array, and are accommodated at sites remote in space from the photodiode array.

### SUMMARY

In at least one embodiment, the invention proposes a radiation detector for x radiation in the case of which electronic subassemblies, chiefly those serving for signal processing, are integrated in the photodiode array.

In at least one embodiment, electronic subassemblies are arranged in insensitive regions, covered by the partition walls, of the photodiode array, and the partition walls include a material that has an X-ray absorptivity of more than 50%. In at least one embodiment, the invention proceeds here from the idea of using the above named insensitive regions between the individual photodiode pixels to accommodate electronic subassemblies. However, when selecting materials of conventional partition walls importance is chiefly attached to ensuring that the partition walls have the highest possible reflectivity for emission light, but not also a high absorptivity for X-rays. Conventional partition wall material therefore passes a high fraction of the incident X radiation, and so a radiation intensity prevails in the insensitive regions of the photodiodes that would damage electronic subassemblies arranged there. However, in at least one embodiment, inventive partition walls absorb at least a certain fraction of X radiation, specifically more than 50%, and so X radiation of reduced intensity is applied to electronic components arranged in the insensitive regions. Depending on the absorptivity of the partition wall material, it is then possible to arrange more or fewer sensitive electronic subassemblies in the edge regions of the photodiodes.

In order to be able to utilize the highest possible fraction of the emission light generated in the scintillators, the partition wall material has a reflectivity of more than 90%, as also in the case of conventional radiation detectors.

In a preferred design variant, the partition walls include a matrix with particles incorporated therein and composed of an oxide of a metal of the fifth or sixth period of the periodic system (PSE), in particular with oxides of the transition elements of these periods, the oxides having a refractive index of at least 1.8. The matrix can be, for example, a two-component casting resin that can easily be cast during production of a radiation detector into gaps that separate the individual scintillators of an array from one another. With regard to a raised absorptivity for x radiation, the best results are obtained with particles that contain at least one oxide of the group Ta₂O₅, WO₃, HfO₂, Gd₂O₃, Nb₂O₃, Y₂O₃, ZrO₂, it also being possible to conceive mixed oxides from one or more of the oxides named, or different particles with a composition differing from one another. Thus, Nb₂O₅ and Ta₂O₅ exhibit the best results with reference to reflection and transmission of the emission light, while Gd₂O₃, HfO₂ and Ta₂O₅ exhibit the highest X-ray absorptivity. Consequently, a mixture of the oxides is conceivable for reasons of optimization.

The particles used have an average grain size of 0.1 μm to 10 μm, an optimum optical reflectivity in conjunction with high X-ray absorption being achieved for grain sizes of less than approximately 1.0 μm and, in particular, for two levels of more than 25% by volume.

For example, in the case of a nonoptimum optical reflectivity of the radiation absorbing particles, this can be increased by additionally introducing TiO₂ particles into the partition walls. The optical reflectivity can also be increased by using radiation absorbing particles that are sheathed with a layer of TiO₂.

### BRIEF DESCRIPTION OF THE DRAWINGS

The invention is now explained in more detail with reference to example embodiments and the attached drawing, wherein:

The drawing FIGURE shows a section of a radiation detector in a perspective illustration.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

As used herein, the terms “and/or” and “at least one of” include any and all combinations of one or more of the associated listed items.

As shown in example embodiment shown in the FIGURE, a radiation detector 1 includes a detector array 2 and a photodiode array 3 arranged on the side of said detector array averted from the radiation, the two arrays having substantially the same grid size. The detector array 2 is formed from a multiplicity of scintillators 4, the scintillators 4 being separated from one another by gaps 5.

For the scintillators 4, conventional luminescent materials such as, for example, metal oxysulphide of the general empirical formula (M₁₋ₓLN₂)₂ O₂S are doped with lanthanide (Ln). The gaps 5 are filled up with a composition that is initially flowable and later solidifying, forming partition walls 6. The width of the partition walls 6 is between 50 μm and 500 μm.

The starting composition for the partition walls 6 is a two-component casting resin in which particles (not illustrated) are incorporated that have a high refractive index and consequently reflect the light emitted by the scintillators 4 upon application of X radiation. For one thing, this has the effect of increasing the light yield and, secondly, of preventing emission light of a scintillator from passing into a neighboring scintillator. Moreover, the particles used have a high absorptivity for X-rays, and therefore fulfill a double function by, on the one hand, improving the light yield and the crosstalk behavior of the detector array 2, and, on the other hand, absorbing X-rays.

Materials exhibiting these properties are oxides of metals of the fifth and sixth period, in particular of the transition elements, Ta₂O₅, WO₃ HfO₂, Gd₂O₃, Nb₂O₃, Y₂O₃ and ZrO₂ being particularly suitable here. It was possible to establish by suitable measurements that the X-ray absorptivity of Y₂O₃, ZrO₂ and Nb₂O₃ is increased five fold in the case of a standard fill level of 25% by volume, and nine fold in the case of use of Gd₂O₃, HfO₂ and Ta₂O₅ by comparison with titanium oxide particles at the same fill level. The viscosity of a casting compound is not allowed to be excessively high if said compound is to flow into the gaps without a problem. Since the abovementioned powder materials increase the viscosity of a casting compound, their fraction often cannot be increased to an extent required to achieve the optimum optical properties. In the case of two-component epoxy resins, for example, it is possible to cast given a fraction of approximately 25% by volume of TiO₂ powder particles. Given higher fill levels, the viscosity of the casting compound can be increased by admixing a dispersant.

The photodiode array 3 formed from a multiplicity of photodiodes 7 is arranged on the side of the detector array 2 averted from the radiation. The photodiode 7 has a rectangular outline corresponding to the scintillators 4, the edge length 1 of the photodiodes 7 being dimensioned such that, seen in a projection in the direction of the arrow 9, the imaginary center line 8 between two photodiodes 7 runs on the imaginary center line 10 of the partition walls 6 or the gaps 5. Because of their somewhat larger cross sectional area, in addition to the sensitive surface of the photodiode 7 the scintillators 4 also cover a small part of the insensitive region 12, the remaining part of the insensitive region being covered by the partition walls 6. The partition walls 6 shield a substantial fraction of the X radiation striking the radiation detector 1, and so only a correspondingly reduced x radiation is applied to the insensitive regions 12. It follows that the electronic subassemblies indicated in the insensitive regions 12 of the photodiodes, for example by way of CMOS technology, such as preamplifiers, capacitive or inductive elements, can substantially operate without interference from the X radiation. It is possible in this way to provide radiation detectors with a higher degree of integration.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A radiation detector for X radiation, comprising:
a detector array including a multiplicity of individual scintillators separated from one another by gaps, the gaps being filled with a casting compound forming partition walls; and
a photodiode array arranged on a side of the detector array, photodiodes of the photodiode array adjoining one another without exposing gaps, electronic subassemblies being arranged in an insensitive region of the photodiodes covered by the partition walls, and the partition walls including an X-ray absorptivity of more than 50%.

2. The radiation detector as claimed in claim 1, wherein the partition wall material includes a diffuse reflectivity of more than 90% in the region of the scintillator emission.

3. The radiation detector as claimed in claim 1, wherein the partition walls are formed from a matrix with particles incorporated therein and are composed of an oxide of a metal of at least one of the fifth and sixth period of the PSE, the oxides including a refractive index of at least 1.8.

4. The radiation detector as claimed claim 1, wherein the particles include at least one oxide of the group Ta₂O₅, WO₃, HfO₂, Gd₂O₃, Nb₂O₃, Y₂O₃, and ZrO₂.

5. The radiation detector as claimed in claim 1, wherein the particles include an average grain size of 0.1 μm to 10 μm.

6. The radiation detector as claimed in claim 5, wherein the particles have an average grain size of less than 1.0 μm.

7. The radiation detector as claimed in claim 1, wherein 10% by volume to 50% by volume of particles are contained in the partition walls.

8. The radiation detector as claimed in claim 3, wherein the partition walls additionally contain TiO₂ particles.

9. The radiation detector as claimed in claim 3, wherein particles containing an oxide of a metal of at least one of the fifth and sixth period are enveloped with a layer of TiO₂.

10. The radiation detector as claimed claim 2, wherein the particles include at least one oxide of the group Ta₂O₅, WO₃, HfO₂, Gd₂O₃, Nb₂O₃, Y₂O₃, and ZrO₂.

11. The radiation detector as claimed in claim 2, wherein the particles include an average grain size of 0.1 μm to 10 μm.

12. The radiation detector as claimed claim 3, wherein the particles include at least one oxide of the group Ta₂O₅, WO₃, HfO₂, Gd₂O₃, Nb₂O₃, Y₂O₃, and ZrO₂.

13. The radiation detector as claimed in claim 3, wherein the particles include an average grain size of 0.1 μm to 10 μm.

14. The radiation detector as claimed in claim 4, wherein the particles include an average grain size of 0.1 μm to 10 μm.

15. The radiation detector as claimed in claim 2, wherein 10% by volume to 50% by volume of particles are contained in the partition walls.

16. The radiation detector as claimed in claim 3, wherein 10% by volume to 50% by volume of particles are contained in the partition walls.

17. The radiation detector as claimed in claim 12, wherein the partition walls additionally contain TiO₂ particles.

18. The radiation detector as claimed in claim 12, wherein particles containing an oxide of a metal of at least one of the fifth and sixth period are enveloped with a layer of TiO₂.

19. The radiation detector as claimed in claim 13, wherein the partition walls additionally contain TiO₂ particles.

20. The radiation detector as claimed in claim 13, wherein particles containing an oxide of a metal of at least one of the fifth and sixth period are enveloped with a layer of TiO₂.
